(19) United States
(12) Patent Application Publication
(10) Pub. No.: US 2021/0271717 A1
(43) Pub. Date: Sep. 2, 2021

(54) DOCUMENT CANCELLATION ENGINE

(71) Applicant: SAP SE, Walldorf (DE)

(72) Inventors: Andre Muller, Speyer (DE); Aalbert Niet, Bammental (DE); Soumya Ranjan Das, Cuttack (IN); Francois Vigneron, Kehl am Rhein (DE)

(21) Appl. No.: 16/805,906

(22) Filed: Mar. 2, 2020

(51) Int. Cl. G06F 16/93; G06F 9/54; G06F 16/901; G06Q 50/18

(52) U.S. Cl. CPC G06F 16/93; G06Q 50/18; G06F 16/901; G06F 9/54

(57) ABSTRACT

Provided is a document cancellation engine that can interact with document management systems and assist in identifying document cancellation actions that are available for an electronic document that has already been submitted. In one example, a method may include receiving an identification of an electronic document from an application, identifying a document type of the electronic document and a jurisdiction where the electronic document has been submitted, determining whether available cancellation actions exist for the electronic document based on the identified jurisdiction and document type, and in response to a determination that available cancellation actions exist, outputting information about the available cancellation actions to the application.

### BACKGROUND

An electronic document is any electronic media content (other than a computer program or a system file) that is intended to be used in either an electronic form or as printed output. The development of computer networks and improvement in electronic visual display technologies has made it possible so that electronic documents are more convenient and easier to distribute and automate than conventional paper documents. Through an electronic visual display (e.g., a document viewer, file viewer, etc.) a user can view the electronic document on a screen rather than printing a physical copy of the document on paper.

In jurisdictions such as Brazil, Chile, Colombia, Mexico, Peru, Italy, Russia, Hungary, Spain, Turkey, and many others, laws, regulations, and business practices mandate the filing of electronic documents. Similar submission requirements exist within business-to-business relationships, customer/retail relationships, logistics interactions, and the like. The submission requirements are often controlled by an electronic data interchange (EDI) or a solution designed to exchange documents with governments. Government can define a wide variety of cancellation rules. For businesses that work in different jurisdictions, it difficult to process cancellations in a legally valid manner. While most organizations are able to implement obvious requirements of electronic documents, there are many exceptions and less known scenarios which are not easy to implement and can consume significant amounts of time.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1A is a diagram illustrating a computing environment of a cancellation engine in accordance with an example embodiment.

FIG. 1B is a diagram illustrating an electronic document cancellation process performed by the cancellation engine of FIG. 1A, in accordance with an example embodiment.

FIG. 1C is a diagram illustrating available cancellation actions that may be output by the cancellation engine of FIG. 1A, in accordance with an example embodiment.

FIG. 2 is a diagram illustrating a process of identifying available cancellation actions in accordance with an example embodiment.

FIG. 3 is a diagram illustrating a user interface for changing cancellation settings user in accordance with example embodiments.

FIG. 4 is a diagram illustrating a method of determining cancellation actions that are available for an electronic document in accordance with an example embodiment.

FIG. 5 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

An electronic document is a form of media with recorded content that requires a computer or other electronic device to display, interpret, and process the electronic document. Electronic documents may include text, graphics, tables, spreadsheets, and the like, which may be generated by software and stored on disk. A business software such as an enterprise resource planning (ERP) software application may be used to generate electronic documents such as invoices, tax documents, purchase orders, dispatch notes, reports, credit/debit notes, and the like. To submit a document, often the software application prepares the document in a required format mandated by a particular jurisdiction, and transmits the document to a portal dedicated by an authority or industry. For example, the format of the electronic may be based on an electronic data interchange (EDI), but embodiments are not limited thereto. In some cases, the business application may provide a portal or other user interface where a user can upload/submit electronic documents which are then transferred to an authority, business partner, or the like, via a network such as the Internet.

Once an electronic document has been submitted, the options available to cancel or revert the electronic document can change from one jurisdiction to the next. Examples of some of the various factors that can affect the cancellation options include legal mandates in the jurisdiction of the document issuer, legal mandates in the jurisdiction of the document receiver, contractual agreements between the issuer and the receiver, and the like. For example, the laws and contracts which regulate how an electronic document can be canceled can be based on various criteria such a type of document (e.g. invoice, credit note, dispatch advice, dispatch note, purchase order, report, etc.), a category of the document type (e.g. cross border, domestic transaction, simple or complex process, etc.), related categories of goods or services (e.g., oil, medication, food, non-food, military, security equipment, etc.), an amount of time that has passed since the initial document was accepted by the receiver or the local authority, whether the document was confirmed or registered or partially registered or confirmed by a business partner or by an authority, and the like.

In some jurisdictions, the cancellation process for one type of document may be different from a required cancellation process for a different type of document. As another example, some jurisdictions may not allow documents to be canceled. As another example, some jurisdictions may require a document be canceled within a predetermined amount of time from the submission (e.g., within 24 hours, etc.).

To cancel an electronic document manually often requires a user to enter into a web-based portal to replicate the change from the business application (e.g. ERP) into a government or a provider portal. For international organizations in multiple countries and jurisdictions, there are multiple ways and types of integration to cancel electronic documents. That makes it very difficult for these organizations to keep an overview of what cancellation options are available in a given situation. Even when cancellations are transmitted automatically such as to a middleware or to a document processing application, the application may throw an error because it cannot handle such requests or send a cancellation request to a target endpoint without knowing whether the endpoint can handle such cancellations. As a result, errors often occur at the endpoint or the processing application that are not reported to the business application.

The example embodiments overcome these drawbacks with a document-based cancellation engine. The cancellation engine can be implemented as a web service, cloud service, or other program, which can interact with existing document processing systems. The cancellation engine can receive a request from an application with respect to an electronic document to be canceled, and identify what cancellation actions are available for the electronic document based on attributes of the document such as document type, jurisdiction, category of the document, and the like. The cancellation engine may output the available cancellation actions to the business application where they can be implemented automatically and without the need for manual cancellation. Accordingly, the cancellation engine addresses the complexity of canceling an electronic document by providing a way to define and manage cancellations rules across jurisdictions, document types, business partners, and the like.

For example, the cancellation engine may include document-based rules for different jurisdictions, document types, and the like. The cancellation engine may also include a portal or other interface which enables admin users the ability to modify the cancellation actions available for different jurisdictions (e.g., to address changes in laws, preference, etc.). The cancellation engine may also include a trigger mechanism which can request external sources for cancellation information when the cancellation engine lacks such information. For example, for some scenarios or jurisdictions, the cancellation engine may communicate with an external endpoint and retrieve additional information about possible document cancellation actions.

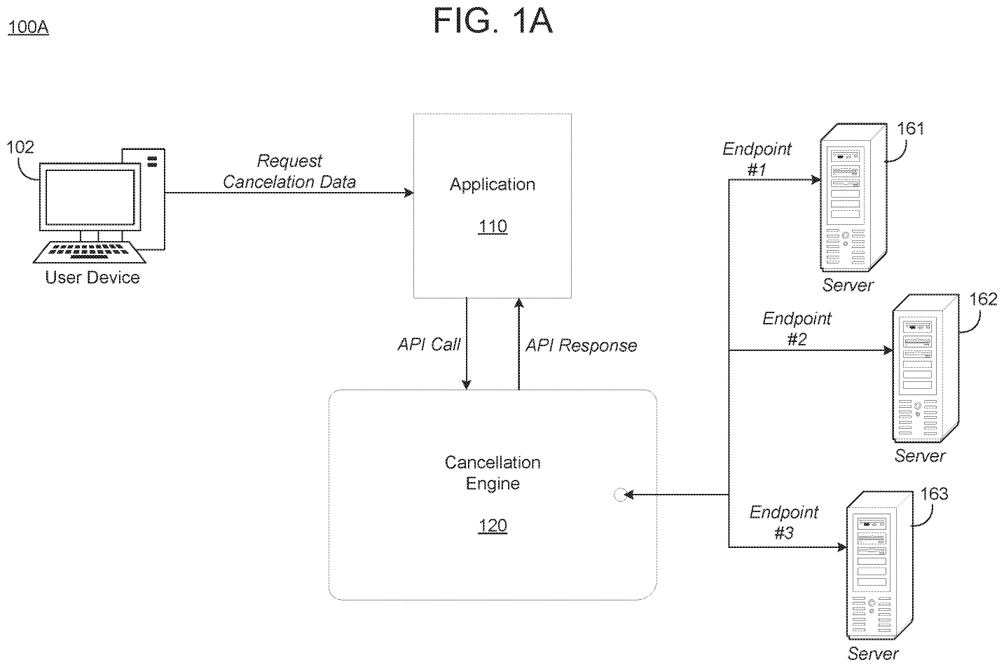

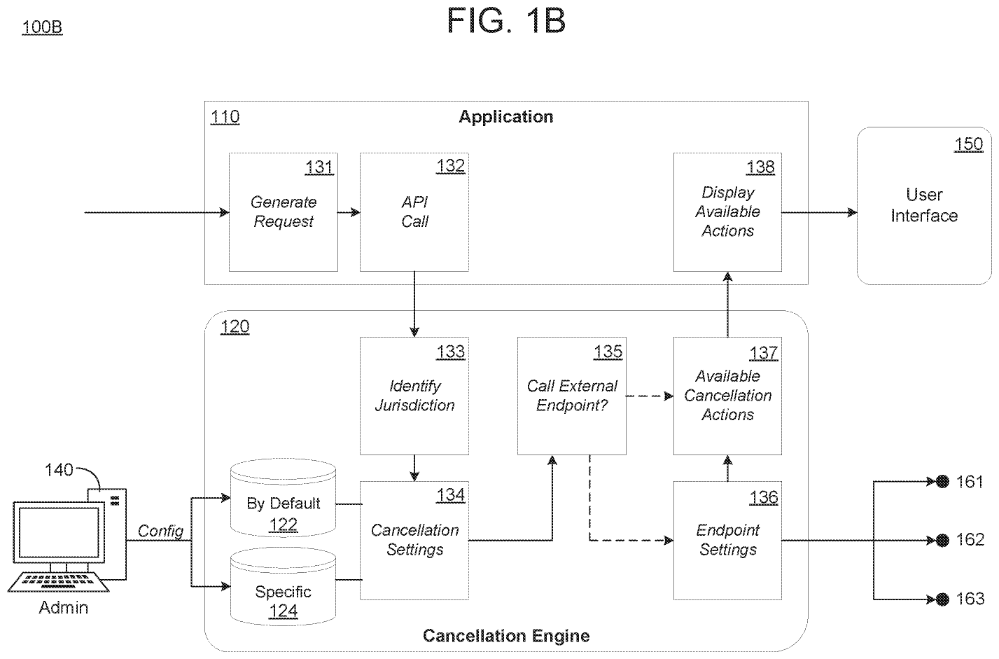

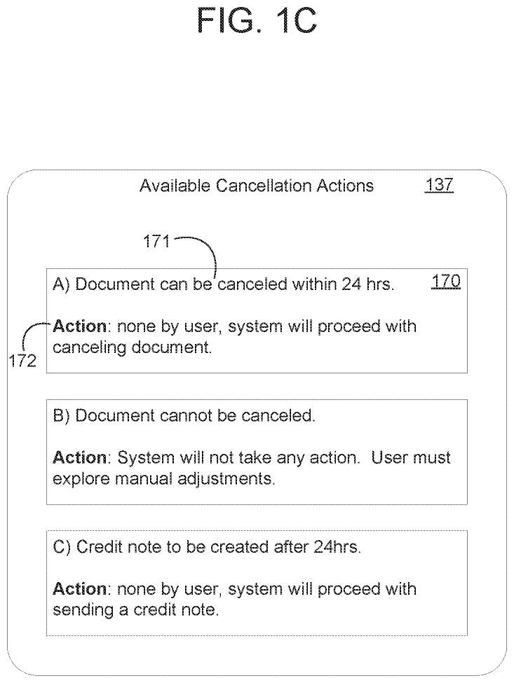

FIG. 1A illustrates a computing environment 100A of a cancellation engine 120 in accordance with an example embodiment, and FIG. 1B illustrates a process 100B performed by the cancellation engine 120 of FIG. 1A, in accordance with an example embodiment. Referring to FIG. 1A, a user device 102 access a user interface (e.g., electronic document viewer, portal, etc.) provided by an application 110. The application 110 may be an enterprise resource planning (ERP) application, an EDI application, a business software, or the like. In some embodiments, the application 110 may be hosted by a web server (not shown). The user device 102 may connect to the web server via a network such as the Internet.

FIG. 1A further illustrates the cancellation engine 120. For example, the cancellation engine 120 may be an independent service, microservice, application, program, etc., from the application 110. By decoupling the cancellation engine 120 from the application 110, the cancellation engine 120 can be modified/updated over time without a need to modify the application 110. In the example of FIG. 1A, the user device 102 requests information about canceling an electronic document from the application 110. In response, the application 110 determines whether the cancellation information is already stored within the application, for example, based on a jurisdiction, etc. of the electronic document. If the application 110 does not have the cancellation information, the application 110 may transmit a request to the cancellation engine 120. The request may include a call that is transmitted via an application programming interface (API) of the cancellation engine 120.

For example, the request may include a document identifier (e.g., a unique serial number, etc.), a document type (e.g., invoice, purchase order, dispatch advice, credit note, debit note, report, tax document, etc.), a jurisdiction of the document sender, a jurisdiction of the document receiver, a category of the electronic document (e.g., cross-border, domestic transaction, retail, business-to-business, etc.), and the like. The jurisdiction may include an identifier (e.g., a text value) of a city, a country, a state, a province, etc. of the jurisdiction.

In response to receiving the request from the application 110, the cancellation engine may identify attributes of the electronic document from the request, additional sources, etc. For example, the cancellation engine 120 may identify a jurisdiction (sender and/or receiver), a document type, a document category, etc. Based on this information, the cancellation engine 120 may determine whether available cancellation actions exist. For example, the cancellation engine 120 may look-up or otherwise retrieve available cancellation actions that match the identified attributes of the electronic document. Furthermore, the cancellation engine 120 may transmit the available cancellation actions to the application 110 via the API from which the request was received.

In some embodiments, the cancellation engine 120 may be unable to find any available cancellation actions based on the identified attributes of the electronic document. That is, no cancellation actions may exist in the cancellation engine 120. In response to failing to detect a cancellation action, the cancellation engine 120 may trigger one or more endpoints 161-163 for additional information. For example, the cancellation engine 120 may transmit a request to one or more external sources, services, etc., using a predefined URL of the respective endpoints 161, 162, and/or 163. The request may include an identifier of the attributes of the electronic document such as jurisdiction, document type, etc. In response, the endpoints 161, 162, and/or 163 may retrieve cancellation actions available for the electronic document from external sources such as authority websites, electronic manuals, registries, etc., and return the available cancellation actions to the cancellation engine 120. Here, the cancellation engine 120 may forward the received cancellation actions to the application 110.

Based on the available cancellation actions provided from the cancellation engine 120, the application 110 may react based on the response from the cancellation engine 120. For example, the application may output information for display to a user interface on the user device 102. The output information may include a description of the available cancellation actions, mechanisms (inputs, buttons, etc.) for triggering the cancellation process, and the like. In another embodiment, the application 110 may automatically execute the actual cancellation action recommended by the cancellation engine 120.

FIG. 1B illustrates an electronic document cancellation process 100B in accordance with an example embodiment. Referring to FIG. 1B, the process 100B may begin within the application 110 (e.g., a business application, ERP application, etc.) which creates, receives, and/or helps users monitor electronic document transactions such as vendor or customer invoices, logistics messages (purchase orders, dispatch advises) and reports (e.g. tax reports, SAF-T reports).

In 131, the application 110 can create a request for information on cancellation of a document. Cancellations can be requested for single documents or in bulk for several documents depending on the settings of the application 110 and the specifications of the underlying business process of the application 110. Here, the request may be transmitted from the application 110 to the cancellation engine 120 via an API call, in 132. The API call may include an identifier of the electronic document, jurisdiction information, document type information, document category information, and the like. That is, instead of handling the cancellation request in a traditional manner, the application 110 may send the cancellation request to an independent and external service which implements the cancellation engine 120.

In 133, the cancellation engine 120 may analyze the request from the application 110 and identify attributes of the electronic document including one or more of an applicable jurisdiction, document type, document category, and the like. In some embodiments, the cancellation engine 120 may also identify additional criteria such as a category of goods and services, etc. In 134, the cancellation engine may determine available cancellation actions for the document based on the identified attributes such as jurisdiction, document type, etc. For example, the cancellation engine may query or otherwise access a memory (e.g., default storage 122, customer specific storage 124, etc.) storing cancellation settings. The default settings may include generic settings applicable to all jurisdictions. Meanwhile, the customer-specific settings may include unique and dynamic settings of the particular application 110 such as contractual agreements, etc. Furthermore, a user may modify either the default settings in the default storage 122 and/or the customer-specific storage 124.

In 135, the customer and by-default settings may be used to determine/verify whether the cancellability of the document requires further investigation via one or several endpoints. If an endpoint needs to be triggered, the cancellation engine 120 can submit a request in 136. Endpoint checks can be triggered for several reasons. For example, an endpoint may be triggered if an amount of time that has passed since the initial document was accepted by the receiver or the local authority is not logged directly in the cancellation engine 120, but available from another endpoint such as an official/authority site, a provider a business application, or the like. As another example, the endpoint may be triggered if a status of the electronic document requires one or more of a business partner, provider or an authority to evaluate the cancellability of the electronic document.

In some embodiments, based on the required endpoint, endpoint settings may be retrieved from the default storage 122 and/or the customer storage 124, and used to call the determined endpoints. Thus, the customer may use the built-in endpoints as well as modify the endpoints to their own custom endpoints of choice. Depending on its capabilities, the endpoint can give a positive response (document can be reversed), a negative response (document cannot be reversed), an indication that the document can be cancelled with a credit note or similar document type, a simple document status, and the like. In some cases, the endpoint might also provide information that needs further interpretation by the cancellation engine 120 (e.g., a processing time an external entity needs to be evaluated against a remaining time for cancellability, etc.)

If the cancellation engine 120 detects that the document can be canceled from either the cancellation settings in 134, or the endpoint checks in 136, the cancellation engine 120 may directly cancel the electronic document. As another example, in 137 the cancellation engine 120 may send back an indication that the electronic document can “positively be canceled. In the latter case, the application 110 that will in turn proceed with the cancellation. That is, the cancellation engine 120 may provide available cancellation actions to the application 110 and enable the application 110 to perform the cancellation of the electronic document. Here, the application 110 may display the available cancellation actions in 138.

Examples of the available cancellation actions that are transmitted from the cancellation engine 120 to the application 100 are shown in FIG. 1C. In this example, there are three possible cancellation actions that are shown. However, it should be appreciated that the example embodiments are not limited hereto. In this example, each action 170 includes an indicator 171 of whether the electronic document can be canceled, and a description 172 of the action to be performed by the system (e.g., the application 110 and/or the cancelation engine 120) and/or a user who is associated with the electronic document.

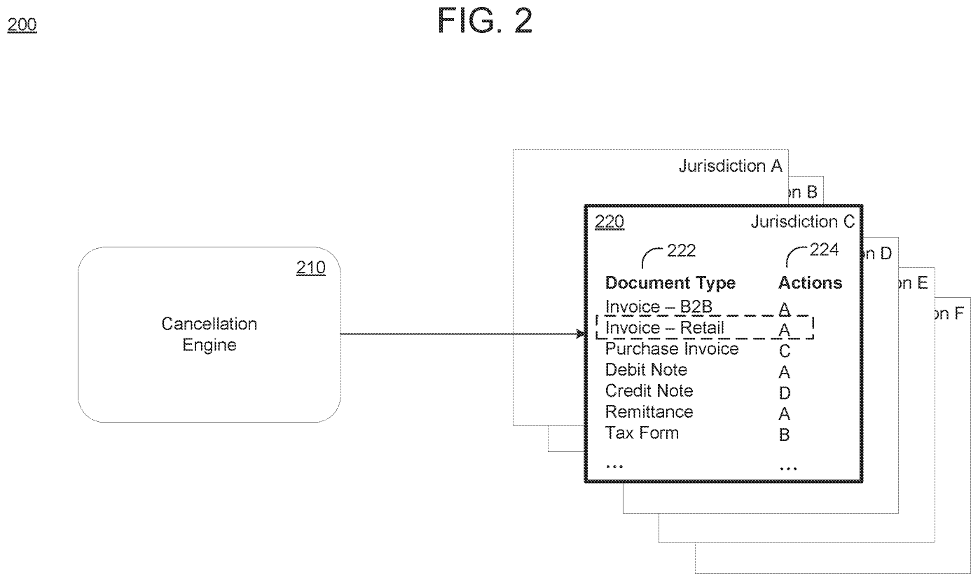

FIG. 2 illustrates a process 200 of a cancellation engine 210 identifying cancellation actions in accordance with an example embodiment. In this example, the cancellation engine 210 may correspond to the cancellation engine 120 shown in FIGS. 1A-1C. Referring to FIG. 2, the cancellation engine may store document cancellation settings in a memory that is local to the cancellation engine 210 (e.g., the default storage 122 and/or the customer-specific storage 124) shown in FIG. 1B. As another example, the cancellation engine 210 may store document cancellation settings in an external memory that is accessed via a network, etc.

In the example of FIG. 2, each jurisdiction includes its own data structure 220 with a document type 222 and available actions 224 stored therein. As a non-limiting example, the data structure 220 may be a table with rows/columns of data in cell format. As another example, the data structure 220 may be a document, a spreadsheet, a NoSQL storage, and the like. Here, each data structure 220 corresponds to a different jurisdiction. Within each jurisdiction, the document types 222 and the available actions 224 may differ. It should be appreciated that how the cancellation settings are stored in FIG. 2 is just an example. As another example, the cancellation engine 210 may store all document cancellation settings in one data structure.

When a cancellation request is received, the cancellation engine 210 may identify a jurisdiction within the request, and identify the corresponding data structure 220, including available actions 224, for the identified jurisdiction. Furthermore, the cancellation engine 210 may identify a document type (or some other attribute such as document category, etc.) and identify the available cancellation options based on a combination of the attributes.

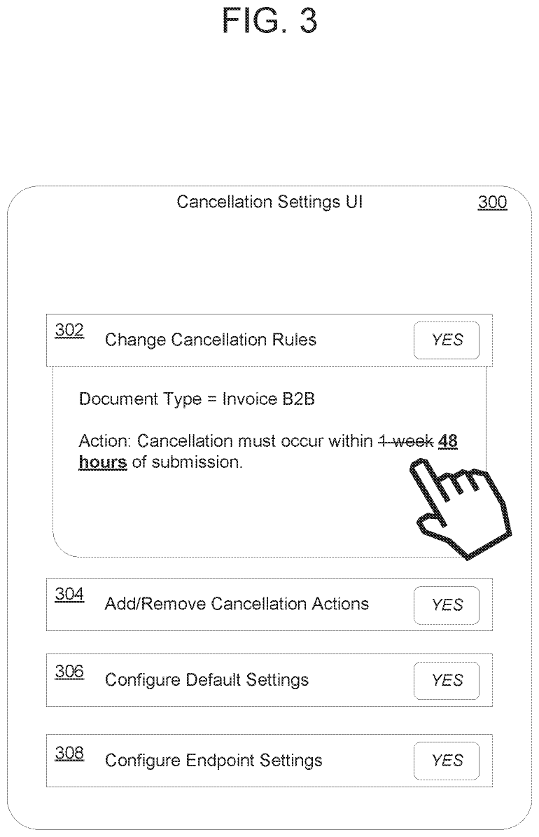

FIG. 3 illustrates a cancellation settings user interface 300 in accordance with example embodiments. As shown in FIG. 1B, a user (e.g., admin 140) may access cancellation settings of the cancellation engine 120 and dynamically modify/configure the cancellation settings for various jurisdictions. In other words, a user can dynamically modify the default settings that are built into the cancellation engine 120 with their own settings or with any changes in laws/regulations that occur.

In the example of FIG. 3, the cancellation settings user interface 300 includes selectable options 302, 304, 306, and 308 as examples. Here, a user may select option 302 to change the cancellation rules. For example, the user may change the actual text or values within the text of the cancellation action. In the example of FIG. 3, a user is changing a value of a time period by which a document must be canceled to reflect a change in regulations. Other changes that the user can make include adding or removing cancellation actions, changing the default settings of any cancellation action, configuring the endpoints that are to be called when the cancellation engine cannot find available cancellation actions for a particular jurisdiction, and the like.

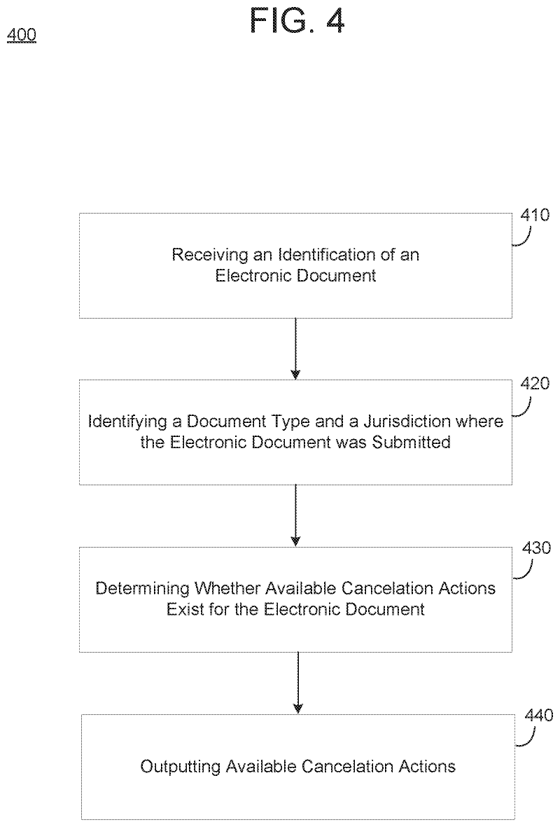

FIG. 4 illustrates a method 400 of determining cancellation actions available for a previously submitted electronic document in accordance with an example embodiment. For example, the method 400 may be performed by a service, an application, a program, or the like, which is executing on a host platform such as a database node, a cloud platform, a web server, an on-premises server, another type of computing system, or a combination of devices/nodes. Referring to FIG. 4, in 410, the method may include receiving an identification of an electronic document from an application. For example, the identification may include an identification of a document to be canceled. The identification may include a serial number or unique value identifying the exact document. As another example, the identification may include attributes of the electronic document such as document type, document category, jurisdiction of sender, jurisdiction of receiver, and the like. The document identification data may be received from an external software application, via an application programming interface.

In 420, the method may include identifying a document type of the electronic document and a jurisdiction where the electronic document has been submitted. The document type and the jurisdiction may be identified from the document attributes included in the request. The jurisdiction may be a state, a country, a province, etc. The jurisdiction may encompass a geographical area as well as unique laws/regulations for electronic documents including cancellation actions. Examples of document types include invoices, dispatch advice, debit/credit notes, reports, and the like.

In 430, the method may include determining whether available cancellation actions exist for the electronic document based on the identified jurisdiction and document type. For example, the method may include accessing a memory location storing a table or other data structure associated with a particular jurisdiction and/or document type. The table may include a description of available cancellation actions that can be performed. Furthermore, in 440, in response to a determination that available cancellation actions exist, the method may further include outputting information about the available cancellation actions to the application.

As another example, in response to a determination that available cancellation actions do not exist, the method may further include transmitting a request to an endpoint based on the identified jurisdiction. The endpoint may include an external service that can provide additional cancellation information based on a specific jurisdiction. Here, the request that is transmitted to the endpoint may include an identifier of the jurisdiction that the cancellation engine seeks additional cancellation action information about. In some embodiments, the transmitting may include triggering the endpoint to search external resources for possible cancellation actions.

In some embodiments, the method may further include modifying default available cancellation actions of the identified jurisdiction with newly defined cancellation actions entered via a user interface. In some embodiments, the modifying may include changing text content of a default cancellation action based on input received via the user interface. In some embodiments, the outputting may include outputting a data structure comprising structured text describing a process of how the electronic document is canceled. In some embodiments, the outputting comprises outputting a data structure comprising structured text describing when in time the electronic document must be canceled. Here, the outputting may be performed via the same application programming interface from which the document identifier was received.

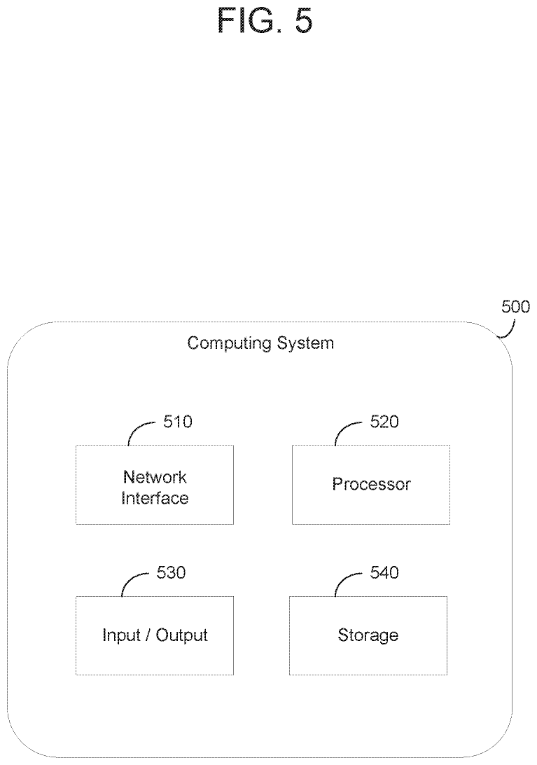

FIG. 5 illustrates a computing system 500 that may be used in any of the methods and processes described herein, in accordance with an example embodiment. For example, the computing system 500 may be a database node, a server, a cloud platform, a user device, or the like. In some embodiments, the computing system 500 may be distributed across multiple computing devices such as multiple database nodes. Referring to FIG. 5, the computing system 500 includes a network interface 510, a processor 520, an input/output 530, and a storage device 540 such as an in-memory storage, and the like. Although not shown in FIG. 5, the computing system 500 may also include or be electronically connected to other components such as a display, an input unit(s), a receiver, a transmitter, a persistent disk, and the like. The processor 520 may control the other components of the computing system 500.

The network interface 510 may transmit and receive data over a network such as the Internet, a private network, a public network, an enterprise network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or reconfigurable. The input/output 530 may include an interface, a port, a cable, a bus, a board, a wire, and the like, for inputting and outputting data to and from the computing system 500. For example, data may be output to an embedded display of the computing system 500, an externally connected display, a display connected to the cloud, another device, and the like. The network interface 510, the input/output 530, the storage 540, or a combination thereof, may interact with applications executing on other devices.

The storage device 540 is not limited to a particular storage device and may include any known memory device such as RAM, ROM, hard disk, and the like, and may or may not be included within a database system, a cloud environment, a web server, or the like. The storage 540 may store software modules or other instructions which can be executed by the processor 520 to perform the method shown in FIG. 4. According to various embodiments, the storage 540 may include a data store having a plurality of tables, partitions and sub-partitions. The storage 540 may be used to store database objects, records, items, entries, and the like, associated with document cancellation policies.

According to various embodiments, the processor 520 may receive an identification of an electronic document from an application. For example, the processor 520 may receive a message, etc., which includes one or more of a document ID, document type, jurisdiction information (sender and/or receiver), document category, and the like. The processor 520 may identify a document type of the electronic document and a jurisdiction where the electronic document has been submitted. For example, the processor 520 may read information from the request and identify the information via parsing, etc.

According to various embodiments, the processor 520 may determine whether available cancellation actions exist for the electronic document based on the identified jurisdiction and document type. In response to a determination that available cancellation actions exist (e.g., stored within a data structure of the storage 540, etc.), the processor 520 may output information about the available cancellation actions to the application. As another example, in response to a determination that available cancellation actions are not present or stored in the memory such as storage 540, the processor 520 may trigger or otherwise call an external service by transmitting a request to an external endpoint.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a processor configured to
receive an identification of an electronic document from an application;
identify a document type of the electronic document and a jurisdiction where the electronic document has been submitted,
determine whether available cancellation actions exist for the electronic document based on the identified jurisdiction and document type, and
in response to a determination that available cancellation actions exist, output information about the available cancellation actions to the application.

2. The computing system of claim 1, wherein the processor is configured to receive the identification of the electronic document via an application programming interface.

3. The computing system of claim 1, wherein the processor is further configured to, in response to a determination that available cancellation actions do not exist, transmit a request to an endpoint based on the identified jurisdiction.

4. The computing system of claim 3, wherein the processor is configured to trigger the endpoint to search external resources for possible cancellation actions.

5. The computing system of claim 1, wherein the processor is further configured to modify default available cancellation actions of the identified jurisdiction with newly defined cancellation actions entered via a user interface.

6. The computing system of claim 5, wherein the processor is configured to change text content of a default cancellation action based on input received via the user interface.

7. The computing system of claim 1, wherein the processor is configured to output a data structure comprising structured text describing a process of how the electronic document is canceled.

8. The computing system of claim 1, wherein the processor is configured to output a data structure comprising structured text describing when in time the electronic document must be canceled.

9. A method comprising:
receiving an identification of an electronic document from an application;
identifying a document type of the electronic document and a jurisdiction where the electronic document has been submitted;
determining whether available cancellation actions exist for the electronic document based on the identified jurisdiction and document type; and
in response to a determination that available cancellation actions exist, outputting information about the available cancellation actions to the application.

10. The method of claim 9, wherein the receiving comprises receiving the identification of the electronic document via an application programming interface.

11. The method of claim 9, further comprising, in response to a determination that available cancellation actions do not exist, transmitting a request to an endpoint based on the identified jurisdiction.

12. The method of claim 11, wherein the transmitting comprises triggering the endpoint to search external resources for possible cancellation actions.

13. The method of claim 9, further comprising modifying default available cancellation actions of the identified jurisdiction with newly defined cancellation actions entered via a user interface.

14. The method of claim 13, wherein the modifying comprises changing text content of a default cancellation action based on input received via the user interface.

15. The method of claim 9, wherein the outputting comprises outputting a data structure comprising structured text describing a process of how the electronic document is canceled.

16. The method of claim 9, wherein the outputting comprises outputting a data structure comprising structured text describing when in time the electronic document must be canceled.

17. A non-transitory computer-readable medium comprising instructions which when read by a processor cause a computer to perform a method comprising:
receiving an identification of an electronic document from an application;
identifying a document type of the electronic document and a jurisdiction where the electronic document has been submitted;
determining whether available cancellation actions exist for the electronic document based on the identified jurisdiction and document type; and
in response to a determination that available cancellation actions exist, outputting information about the available cancellation actions to the application.

18. The non-transitory computer-readable medium of claim 17, wherein the receiving comprises receiving the identification of the electronic document via an application programming interface.

19. The non-transitory computer-readable medium of claim 17, wherein the method further comprises, in response to a determination that available cancellation actions do not exist, transmitting a request to an endpoint based on the identified jurisdiction.

20. The non-transitory computer-readable medium of claim 19, wherein the transmitting comprises triggering the endpoint to search external resources for possible cancellation actions.
